(19) United States
(12) Patent Application Publication
(10) Pub. No.: US 2009/0237358 A1
(43) Pub. Date: Sep. 24, 2009

(54) Computer mouse and method of dynamical data transmission rate management therefor

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,191

(22) Filed: Jun. 3, 2009

Related U.S. Application Data
(63) Continuation-in-part of application No. 11/073,664, filed on Mar. 8, 2005.

(51) Int. Cl. G06F 3/033

(52) U.S. Cl. 345/163

(57) ABSTRACT

A computer mouse and a method of dynamical data transmission rate management for the computer mouse are provided. In order to smooth a movement of the cursor in response to the computer mouse, an aspect of dynamical data transmission rate is introduced. Image data is generated as the computer mouse moves firstly. A microprocessor built in the computer mouse then receives the image data. Moving vector is then generated with the image data and a first time interval representing a data rate of the movement is obtained. After pre-processing the image data, shifted data is generated and being queued into a buffer. Particularly, the first time interval is tagged into the shifted data. Next, a second time interval is obtained by measuring a data transmission rate in order to estimate the loading the computer system. The data transmission rate for further data flow controlling is regulated by referring to the first time interval and the second time interval.

### REFERENCE TO RELATED APPLICATIONS

This application is being filed as a Continuation-in-Part of patent application Ser. No. 11/073,664 filed 8 Mar. 2005, currently pending.

### BACKGROUND OF THE INVENTION

1. Field of the Invention

The present invention generally relates to a computer mouse and method of dynamical data transmission rate management for the computer mouse, and more particularly, a queue management technology is introduced into the computer mouse for controlling a shifted data flow in order to smooth the movement of a cursor.

2. Description of Related Art

The widespread interfaces, such as RS-232, PS/2, USB and a wireless transmission, are generally utilized for interconnecting a computer mouse and a computer system. As a user manipulates the computer mouse moving on any flat top, the computer mouse will generate corresponding signals responsive to the movement. Those signals are transferred to the computer system through one of the described interfaces in order to produce a series of instructions for further operations.

Nevertheless, the loading of the computer system is changeable and the system often produces some unpredictable events rendering it unstable. In particular, those unpredictable events may be caused by an instant surge of the data flow, or by a large number of instructions running in a very short period. Somehow some events may not be understood very clearly.

Furthermore, as the data being processed surges in the computer system, the loading of the computer system may instantly raise. At that moment, the system needs to instruct its processor, memories and/or other peripherals to process the data, and it may influence other processes. For instance, a series of signals will be transferred to the computer system via a legacy interface when the user moves the computer mouse. In the meantime as the loading of the computer system instantly raises, the cursor displayed on the screen in response to the movement of the computer mouse may be delayed or result in abnormal shifting. If there is no measure provided for regulating signal transmission, the situation causing unsmooth cursor movement may become worse.

With regard to the various reasons resulting in the delay or abnormal shifting of the cursor, the most conventional tactics adopted by the computer systems are to abandon some segments of signals in order to improve the data flow. However, the abandoned signals will incur the abnormal hopping of the mouse cursor. Since the computer mouse continuously passes the data to the system, the mentioned problems still occurs if there is no any approach provided.

In order to deal with the signaling between the computer mouse and the computer system, the prior technology referring to U.S. Pat. No. 6,310,607 (Amemiya) illustrates a mouse device with a timing detection scheme. The mouse device has a movement detector, a button push detector, a control unit, and a timing unit. By detecting movement of the mouse device in the directions of X and Y axes, and a button push, the relevant information is generated and thereby setting a movement detection interval time.

Reference is made to FIG. 1, wherein a conventional mouse device 1 is shown and including some requisite elements inside, such as the slit disks 2, 3, two pairs of optical sensing components 5, 7 and 4, 6, a ball 10, a push button switch 8, and an electronic device 9 having a microcomputer.

In which, one pair of the optical sensing components 4, 6 is used to generate X-axis direction movement information, and the other pair of the components 5, 7 is used to generate Y-axis direction movement information. In such a mouse device, an LED in each pair of the optical sensing components is provided to be switched on and off so as to generate optical pulses and transmit the information.

The mouse device 1 is particularly equipped with a microcomputer which provides for the movement detection interval time, which is used to determine an operation state and an idle state for the mouse device.

### SUMMARY OF THE INVENTION

In view of the problems to the operation of computer mouse causing the abnormal movement or hopping of the cursor in the conventional computer system and the mouse, a computer mouse and a method of dynamical data transmission rate management for the claimed computer mouse of the present invention are provided. The schemes of dynamical data transmission rate and queue management for controlling the data flow to the computer system also differ from the conventional way to deal with the operation of a computer mouse.

According to one of the preferred embodiments, the data transmission rate is dynamically changed as referring to some parameters, such as a first time interval representing the data rate of generating the image data as the computer mouse moves, and a second time interval representing what the situation the computer system retrieves the data from the computer mouse.

Firstly, the image data is generated in response to the mouse movement. A moving vector in accordance with the received image data is then generated. Next, a first time interval representing the data rate of the movement according to the moving vector is obtained. Through a pre-processing step on the image data, the shifted data is generated and queued into a queue buffer in the meantime. The first time interval is particularly tagged into the shifted data. After that, a second time interval is obtained by measuring a data transmission rate of the computer system retrieves the data from the computer mouse. Thereby, it is to estimate the loading the computer system.

By referring to the first time interval tagged in the shifted data and the second time interval, the data transmission rate is regulated for adjusting a data flow from the computer mouse to the computer system.

The above-described method is applied to a computer mouse which particularly includes a built-in microprocessor. In order to smooth the movement of the cursor displayed on a screen, the microprocessor preferably incorporates an aspect of queue management of the shifted data. In the computer mouse, a sense image processor is used to generate image data as the computer mouse moves.

In the microprocessor, an image data processing unit produces shifted data after pre-processing the image data, and the first time interval is calculated in reference with the shifted data. Then an image queue management unit queues the shifted data into a buffer. As the computer mouse continuously generates image data being transmitted to the computer system, a second time interval is obtained by measuring the data transmission rate. The data transmission rate is regulated by preferably referring to the first time interval and the second time interval. A data shifting unit is used to control data flow of the shifted data according to the data transmission rate.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a conventional mouse device having a microcomputer;

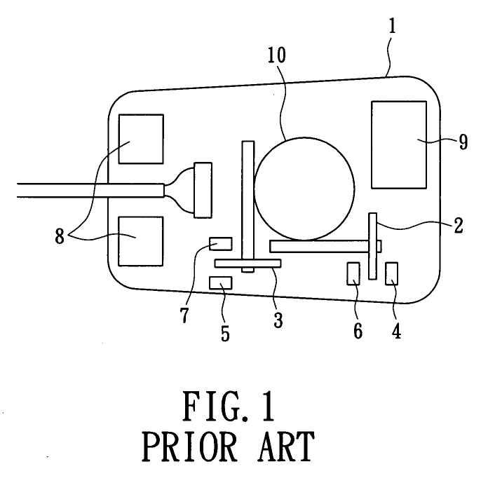

FIG. 2 shows a functional block of a computer mouse of the embodiment of the present invention;

FIG. 3 is flow chart illustrating the method of dynamical data transmission rate management for the computer mouse of the present invention.

### DETAILED DESCRIPTION OF THE EMBODIMENTS

In a conventional computer system, a data bus is disposed to communicate the peripherals, especially the input or output devices. Such as a computer mouse, a USB (Universal Serial Bus) is preferably used for linking to the computer system. To confront with the various reasons resulting in the abnormal movement of the cursor as the loading of the computer system suddenly raises, the conventional computer system tries to mitigate the overload by abandoning some segments of signals. However, the tactics of signal abandonment may still incur the abnormal hopping of the mouse cursor.

In order to implement a smooth movement of the cursor, the present invention provides a method of dynamical data transmission rate management for the computer mouse.

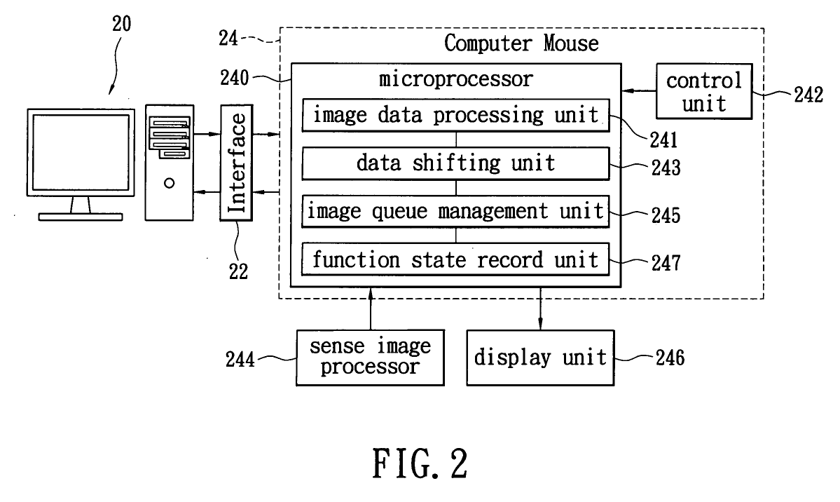

Reference is made to FIG. 2 which shows a functional block of a computer mouse of the embodiment of the present invention. A shown computer mouse 24 connects to a computer system 20 by a wired or wireless connection (the conventional components relating the wired connection or wireless connection are not shown in the figure). The computer mouse 24 particularly introduces an aspect of dynamical data transmission rate by referring to time intervals measured as the computer mouse receives the data as moving and the data signaling to the computer system.

In the embodiment, the computer mouse 24 particularly includes a microprocessor 240 that receives image data from a sense image processor 244, and being initiated by a control unit 242. The microprocessor 240 includes an image data processing unit 241, a data shifting unit 2 43, an image queue management unit 245, and a function state record unit 247. The microprocessor 240 generates the signals conveyed to the computer system 10 through an interface 22.

A sense image processor 244 is provided to electrically connect with the microprocessor 240. When a user moves the computer mouse 24 connected to the computer system 20 and the movement is detected by the sense image processor 244, image data is generated as it takes images through the built-in optical sensor and the relevant components. Particularly the image data can be described as a moving vector which illustrates the moving direction and distance relating the movement. Preferably, the moving vector is formed by the moving direction and distance, and by means of microprocessor 240, the direction and distance can be obtained by extracting the information implied in the image data. Further a time interval as the microprocessor 240 receives the image data is implied in the moving vector, and is used to be one parameter for regulation of the data transmission rate. The image data is further under a pre-processing operation performed by the microprocessor, and transformed into shifted data that is produced by the image data processing unit 241. In which, the image data processing unit 241 is electrically connected with the sense image processor 244.

Since the control unit 242 initiates the image data processing unit 241 by a button push or any other similar way manipulated by a user, the image data processing unit produces the shifted data. The image queue management unit 243 collects the shifted data consequently, and queues the shifted data into a queue buffer.

In the microprocessor 240, the image queue management unit 243 is electrically connected with the image data processing unit 241. When the shifted data is generated, the image queue management unit 243 operates the shifted data to be arrayed into the queue buffer for further operation, especially to control the data flow of the shifted data based on a data transmission rate being regulated.

Next, the data shifting unit 245 is provided to be electrically connected with the image queue management unit 243. The data shifting unit 245 is functionally used to regulate a data transmission rate. An original rata transmission rate is referred by the signal transmission between the computer mouse and the computer system. Based on the timing information of queued shifted data and the original data transmission rate, the data shifting unit 245 is to control data flow of the shifted data according to the regulated data transmission rate.

Moreover, the function state record unit 247 is provided to display a function state of the computer mouse through a display unit 246. The function state record unit 247 is preferably connected with the data shifting unit 245, and collects the information of data flow. The display unit 246 is preferably an LED which is used to indicate the function state responsive to the data flow.

Furthermore, the shown computer mouse of the preferred embodiment may has a radio frequency module (not shown in the figure) electrically connected to the microprocessor 240 when the computer mouse is implemented as a cordless mouse. The radio frequency module periodically outputs a packet to the computer system through the interface using a wireless access protocol.

More, the control unit 242 may be implemented as one or more buttons that are provided for initiating the operative function of queue management and the scheme of the dynamical data transmission rate.

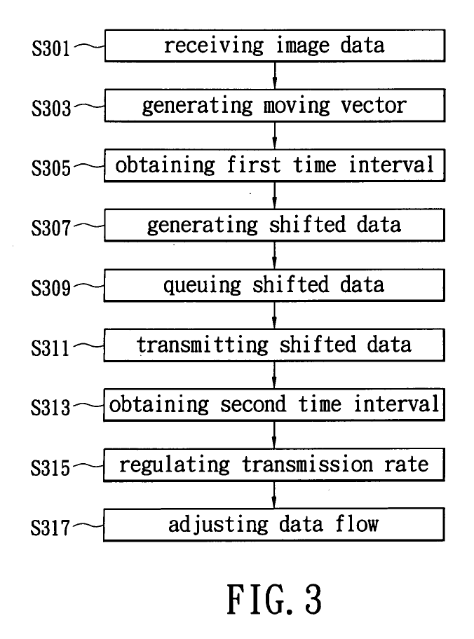

In particular, the above-described data transmission rate is regulated by referring to the timing information of queued shifted data and the original data transmission rate. Reference is made to FIG. 3 which is flow chart illustrating the method of dynamical data transmission rate management for the computer mouse of the present invention.

In the beginning, the connection between the computer mouse and the computer system is well established. When the user moves the computer mouse, the cursor displayed on the computer screen shifts correspondingly. As the step S301, the sense image process generates image data as the computer mouse moves, in which the image becomes the signaling medium as the built-in optical sensor takes the image periodically as moving the optical computer mouse. Then the microprocessor receives the image data and generates the moving vector that is used to describe the direction and distance regarding the movement of the mouse or cursor (step S303).

In step S305, a first time interval is then obtained by measuring the time interval as the microprocessor receives the image data. Particularly, the first time interval represents a data rate of the movement as extracting the timing information implied in the moving vector.

Next, in step S307, the image data processing unit generates the shifted data after pre-processing the image data performed by the microprocessor. The shifted data is temporarily queued into a queue buffer for further analysis (step S309). The first time interval is the first reference for the regulation of the data transmission rate. Since the shifted data is formed as a series of data bits capable of tagging the relevant information. The first time interval can be preferably tagged into the shifted data that will be transmitted to the computer system.

The original data transmission rate is generally used for the data flow between the computer system and the compute mouse, and particularly, the data transmission rate of the present invention is changeable responsive to the actual situation in order to smooth the movement of the cursor displayed on the screen.

The mentioned shifted data is transmitted to the computer system via an interface based on the data transmission rate (step S311). Generally, the computer system periodically checks and retrieves the shifted data queued into the buffer by a polling scheme. The data transmission rate reveals the signaling situation between the computer system and the computer mouse, and the current loading of the system can be recognized. In the meantime, the data transmission rate being referred to retrieve the shifted data can be used to calculate the second time interval. Actually, the second time interval is obtained by measuring the time interval implied in the data transmission rate, the loading the computer system can be estimated (step S313).

Comparatively, the second time interval is the second reference for the regulation of the data transmission rate. In the present invention, a preset proportion is pre-determined by referring to a user's preference or based on the detection, and the performance of the computer system. Particularly this pre-determined proportion is used to determine a new proportion by referring to a proportional combination of the first time interval tagged in the shifted data and the second time interval. This new proportion of combining the first time interval and the second time interval is also dynamical, and used to be referred to regulate the data transmission rate (step S315).

Consequently, after the regulated data transmission rate is obtained, the method is then to adjust a data flow of the shifted data transmitted to the computer system based on the data transmission rate (step S317).

To sum up, by utilizing the described computer mouse and the method of dynamical data transmission rate with queue management, the invention not only solves the abnormal shifting or hopping phenomenon occurred to the mouse cursor, but also smoothes the movement on the screen.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method of dynamical data transmission rate management for a computer mouse connected to a computer system, comprising:
receiving image data representing movement of the computer mouse;
generating a moving vector in accordance with the received image data;
obtaining a first time interval representing a data rate of the movement by measuring time interval implied in the moving vector;
pre-processing the image data into shifted data and tagging the first time interval into the shifted data;
queuing the shifted data into a queue buffer;
transmitting the shifted data to the computer system via an interface based on a data transmission rate;
obtaining a second time interval by measuring the data transmission rate in order to estimate loading of the computer system; and
regulating the data transmission rate by referring to a proportion of combining the first time interval tagged in the shifted data and the second time interval.

2. The method of claim 1, wherein the computer mouse has a microprocessor disposed therein for receiving the image data generated as the computer mouse moves, generating the moving vector, calculating the first and second time intervals, obtaining the shifted data, and regulating the data transmission rate.

3. The method of claim 1, further comprising a step of adjusting the data flow of the shifted data transmitted to the computer system based on the data transmission rate after the data transmission rate is obtained.

4. The method of claim 1, wherein the image data is generated by a sense image processor as detecting the movement of the computer mouse.

5. The method of claim 1, wherein the interface is a polling I/O, by which the computer system periodically checks and retrieves the shifted data.

6. The method of claim 5, wherein the data transmission rate to retrieve the shifted data is used to calculate the second time interval.

7. The method of claim 1, wherein the proportion is originally determined by referring to a user's reference and performance of the computer system.

8. The method of claim 7, wherein the proportion is used to determine a new proportion by referring to a proportional combination of the first time interval tagged in the shifted data and the second time interval.
to the first time interval and the second time interval, a proportion is determined.

9. A computer mouse applying the method of dynamical data transmission rate management claimed in claim 1, the computer mouse comprising:
a sense image processor for generating image data as the computer mouse moves;
a microprocessor including an image data processing unit, an image queue management unit and a data shifting unit; wherein
the image data processing unit electrically connected with the sense image processor, for producing a shifted data after pre-processing the image data;
the image queue management unit electrically connected to the image data processing unit for queuing the shifted data into a buffer; and
the data shifting unit electrically connected to the image queue management unit for regulating a data transmission rate based on the timing information of queued shifted data and the original data transmission rate, and then controlling data flow of the shifted data according to the regulated data transmission rate.

10. The computer mouse of claim 9, wherein the microprocessor further comprises:
a display unit; and
a function state record unit for displaying a function state of the computer mouse through the display unit.

11. The computer mouse of claim 9, further comprising a control unit, and the image queue management unit is initiated by the control unit.

12. The computer mouse of claim 9, wherein the sense image processor takes images through a built-in optical sensor and generates the image data.

13. The computer mouse of claim 9, wherein the pre-processing of the image data is performed by the microprocessor.
